(19) United States
(12) Patent Application Publication
(10) Pub. No.: US 2022/0104620 A9
(43) Pub. Date: Apr. 7, 2022

(54) SEISMIC BASE ISOLATION SYSTEM FOR BARREL RACKS

(71) Applicant: EQX Global LLC, Napa, CA (US)

(72) Inventors: Paul J. Segas, Napa, CA (US); Don Clyde, Napa, CA (US)

(21) Appl. No.: 17/162,484

(22) Filed: Jan. 29, 2021

Related U.S. Application Data
(63) Continuation of application No. 15/238,697, filed on Aug. 16, 2016, now abandoned.
Application No. 15/238,697 is a continuation of application No. 15/081,707, filed on Mar. 25, 2016, now abandoned.
(60) Provisional application No. 62/344,846, filed on Jun. 2, 2016.

(51) Int. Cl. A47B 97/00; A47B 81/00

(52) U.S. Cl. CPC A47B 97/00; A47B 2097/008; A47B 81/007

(57) ABSTRACT

This base isolation system protects barrel racks from earthquake motions through a pad designed to slide on a prepared surface to critically reduce the amount of energy otherwise transferred to a stack of barrels. The pad is comprised of two layers: a plate, usually steel, and an underlayer, usually a high density plastic. The interaction of the underlayer with the prepared surface depends on a coefficient of static and kinetic friction between the underlayer and the surface that prevents relative movement in normal operation and yet allows the isolation pad to move relative to the surface during a seismic event.

### CLAIM OF PRIORITY AND CROSS REFERENCE TO RELATED APPLICATIONS

This application is a continuation of and claims priority to U.S. patent application Ser. No. 15/238,697, filed Aug. 16, 2016, which is a continuation of and claims priority to U.S. patent application Ser. No. 15/081,707, filed Mar. 25, 2016, which claims priority to U.S. Provisional Application No. 62/344,846, filed Jun. 2, 2016, the entire contents of each of which are hereby incorporated by reference in their entirety.

### FIELD OF THE DISCLOSURE

The present disclosure relates generally to a frictional base isolation system for use in racks to protect wine barrels from seismic damage, and more particularly to a seismic base isolation system for barrel racks.

### BACKGROUND OF RELATED ART

Seismic engineering has long been applied to protecting buildings from the dangers of earthquakes and other tectonic events. Where stiffness was prized in the building of ancient sites like Chichen Itza to help the structure survive the shifting earth, modern architects and engineers prize flexibility to weather the forces of an earthquake. One common system used is base isolation, which allows the structure to move independently of the foundation, thus isolating the base from sudden shifts of the foundation. One of the oldest known examples of an isolated base is the Tomb of Cyrus, a structure dedicated to the first ruler of the Persian Empire.

Modern seismic isolation systems, such as floors or plates designed to isolate equipment from sudden foundational shifts can be important in various applications. In particular, seismic base isolation systems are oftentimes powerful tools of earthquake engineering and often used to isolate non-structural contents of a building and/or sensitive equipment against sudden ground motions, which may be caused by a seismic event, such as earthquake, a natural event, a blast wave, etc. Typical applications for seismic isolation systems including buildings with high value assets, such as data centers, hospitals, museums, manufacturers with critical equipment, warehouses, laboratories and/or any application where it is important to protect critical assets. One goal of any seismic isolation system is to maximize safety, business continuity, and preservation of irreplaceable items.

Many American wine producers are located in tectonically active areas, especially the world-renowned Napa Valley region. A wine barrel can hold about 60 gallons (228 liters) of wine and can weigh more than a quarter ton. Depending on the type of wine to be produced, the wine may spend anywhere from a few months to as many as ten years in a barrel to age.

After the dust settled from the earthquake in August 2014, Napa Valley vintners and their surrounding community lost an estimated $100 million. While modern building codes limited damages to many structures, there is no industry standard or regulation as to barrel storage. Few winemakers had specific systems to protect the storage structures within their buildings in spite of the fact that each barrel can be worth tens of thousands in lost profit if lost in an earthquake.

U.S. Pat. No. 9,097,027 describes a seismic isolation system which uses two plates a base plate and a top plate. The base plate has a textured top surface and the top plate is positioned above it with a non-textured bottom surface. Either surface can have a coating such as polyester or a low surface energy coating to modify the frictional characteristics of the surface. In normal operation, the coefficient of static friction prevents relative motion of the two plates. In a seismic event, the top plate can move relative to the base plate. The system optionally can contained an internal damper to provide displacement control. The whole of U.S. Pat. No. 9,097,027 is incorporated herein by reference in its entirety.

### BRIEF DESCRIPTION OF THE DRAWINGS

FIG. 1 shows a graph of the coefficient of friction between the isolation system and a polished concrete surface for various loads.

FIG. 2A is a perspective view of the isolation system installed under a wine barrel rack according to the teachings of the present disclosure.

FIG. 2B is a perspective view of another example of the isolation system without containers loaded.

FIG. 2C is a perspective view of yet another example of the isolation system without containers loaded.

FIG. 3 is a perspective view of an isolation pad for use with the isolation system of FIG. 1 shown without the container holding structure.

FIG. 4A is a top plan view of the isolation pad of FIG. 2A.

FIG. 4B is a bottom plan view of the isolation pad of FIG. 2A.

FIG. 5 is a cross-sectional view of the isolation pad taken along line 5-5 in FIG. 4.

FIG. 6 is a cross sectional view of the isolation pad taken along line 6-6 in FIG. 5.

FIG. 7 is a side elevated detailed view of the attachment means of the isolation pad of FIG. 2A.

FIG. 8 is perspective view of a cap for use with the isolation pad of FIG. 2A.

FIG. 9 is an exploded view of one end of the isolation pad of FIG. 2A.

FIG. 10 shows a variety of attachment methods between the isolation pad and the container holding structure.

FIG. 11A shows a perspective view of another example of the isolation system loaded using releasable connectors to secure the container holding structure.

FIG. 11B shows a schematic of the example releasable connector shown in FIG. 11A in the closed position.

FIG. 11C shows a schematic of the example releasable connector shown in FIG. 11A in the open position.

FIG. 12A is a top plan view of the isolation pad of FIG. 11.

FIG. 12B is a front plan view of the isolation pad of FIG. 11.

FIG. 12C is a bottom plan view of the isolation pad of FIG. 11.

FIG. 12D is a side elevated view of the isolation pad of FIG. 11.

FIG. 13A is a rear elevated view of the support system of the isolation pad of FIG. 11.

FIG. 13B is a top elevated view of the support system of the isolation pad of FIG. 11.

FIG. 13C is a top elevated view of the support system of the isolation pad of FIG. 11.

### DETAILED DESCRIPTION

Described herein is a technology for, among other things, providing base isolation to protect wine barrels, casks, or other any other container from sudden ground motions, such as an earthquake, blast wave, or other event. In one example, the disclosure relates to a seismic isolation pad comprising at least a plate and a underlayer. In this example, the plate and underlayer are affixed to each other. The container or container holding structure rests on the plate. The underlayer rests on a foundation which can be the ground, floor, building foundation, or any similar structure. One of ordinary skill in the art will recognize that a foundation can be any supporting layer of a structure, and a floor can be the walking surface of a room, which may vary from simple dirt to many-layered surfaces using modern technology, such as stone, wood, bamboo, metal, or any other material that can hold a person's or equipment's weight.

In addition, the coefficients of static and kinetic friction between the underlayer and the foundation can prevent relative movement of the two plates with normal operation and yet allow the plate to move relative to the foundation during a seismic event. In an example, the coefficient of kinetic friction is low so that the underlayer can move relative to the foundation during a seismic event, but not too low so that the stability of the system is maintained when the isolation pad is moving in the seismic event. More particularly, the coefficient of static friction is low so that the isolation pad can begin moving when a seismic event occurs, but is sufficiently high to prevent movement of the pad in normal operation. Similarly, the coefficient of friction of the plate and the container or container holding structure must be sufficiently high that the isolation pad does not move relative to the containers, if it is not affixed.

In one example, the underlayer is in communication with the foundation and the plate is in communication with the container or container holding structure. The plate can be textured, so that the interface between the plate and the container or container holding structure is not smooth. The underlayer (which interfaces with the foundation) is smooth or non-textured, resulting in the desired coefficients of kinetic and static friction between the underlayer and the surface. In another example, an additional material (e.g., a lubricating fluid, plate coating, etc.) may be deposited between the underlayer and the foundation to achieve an optimal or desired coefficient of friction.

In one example, the plate and underlayer may be designed to an optimal thickness. In one example, the plate is 0.25″ steel plate. In another example, the plate may be corrosion-resistant.

In some examples, the plate is welded to the container holding structure. In another example, the disclosed plate is textured with diamond-shaped ridges. Such diamond-shaped ridges create a textured surface and optimize the coefficients of static and kinetic friction between the plate and the container or container holding structure in order to maximize the stability of seismic isolation system both when the foundation is moving and when the foundation is not moving.

In accordance with the present disclosure, a sliding surface (e.g., the foundation or the plate) has a coating forming the underlayer in order to achieve the desired coefficients of kinetic and static friction. The underlayer coating may be made of a material such as polyethylene. For instance, in one example, the plate is made of a suitable material (e.g., steel) and coated with an underlayer of polyethylene. It is appreciated that one of ordinary skill could utilize high density polyethylene (HDPE), ultra-high molecular weight polyethylene (UHMW), polyester triglycidyl isocyanurate (TGIC polyester), a commercially available polyester powder coating, or a silicone-epoxy, low surface energy coating, depending on the situation and desired coefficient of friction.

In operation, the disclosed seismic isolation pad is first placed above a foundation. For example, the underlayer can be set directly on a ground, floor, building, or floor tile. Moreover, one of ordinary skill in the art will recognize that the number, size, and shape of the plate or plates may vary as desired. The container or container holding structure is placed on top of the plate and optionally affixed to it. In one example, the container holding structure is welded to the plate. One of ordinary skill would appreciate that the plate could also be affixed to the container or container holding structure with any conventional means including adhesives, mechanical fasteners, or the like. The coefficients of static and kinetic friction between the underlayer and the foundation prevent relative movement of the two plates with normal operation and yet allow the top plate to move relative to the base plate during a seismic event.

If the coefficient of friction between the foundation and the underlayer is not desirable the floor can be altered to change this property. For instance, if the floor has too low of a coefficient of friction, texture can be added such as ridges in the foundation. More commonly, the coefficient of friction is too high especially because many storage facilities use some form of concrete floors. These conventional floor types include conventional concrete, cementious urethane, epoxy suspended marble and quartz, and epoxy finished flooring.

In the concrete floor example, the floors can be machined or polished to lower the coefficient of friction. For a concrete floor, one example process is done in a series of steps beginning with a coarse diamond wheel. The diamond segments in the wheel are coarse enough to remove minor pits, blemishes, stains, or light coatings from the floor in preparation for final smoothing. This initial rough grinding is generally a three to four step process. The next steps involve fine grinding and lapping of the concrete surface using an internal impregnating sealer. Alternatively, an additional material (e.g., lubricate liquid) may be added between the base plate and the top plate to achieve the desired coefficients of kinetic and static friction.

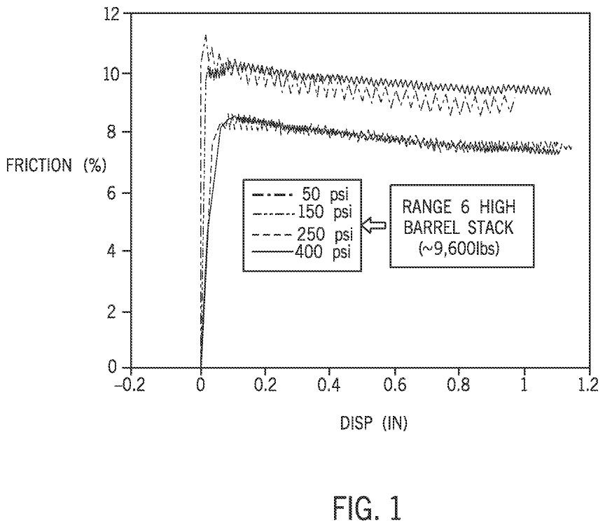

The graph of FIG. 1 shows the effects results of polishing concrete on the coefficient of friction. This chart shows the friction versus displacement for various loads of the system. As is noted, on the graph, the example system maintains an approximant 8% coefficient of friction with a load of 9,600 lbs.

The present disclosure also relates to a seismic isolation system with a damping system. In one example, one or more external dampers are mounted besides the isolation pad and affixed to the plate, container, or container holding structure, in order to limit and/or dampen the movement of container or container holding structure in an earthquake. The damping system can further include one or more internal dampers (e.g., neoprene dampers) mounted on the uncovered part of the plate or the foundation under the container or container holding structure and capable of limiting or damping any movement.

The present disclosure also relates to methods for providing base isolation against earthquake forces. The disclosed method includes at least one of the following steps: adding an underlayer to a plate to create an isolation pad wherein the underlayer is selected to have a suitable coefficient of friction with a foundation to keep the container or container holding structure still under normal operation but allow movement in a seismic event; locating and affixing the isolation pad under the container or container holding structure; and optionally polishing or otherwise altering the foundation (e.g., floor or ground) to refine the coefficient of friction.

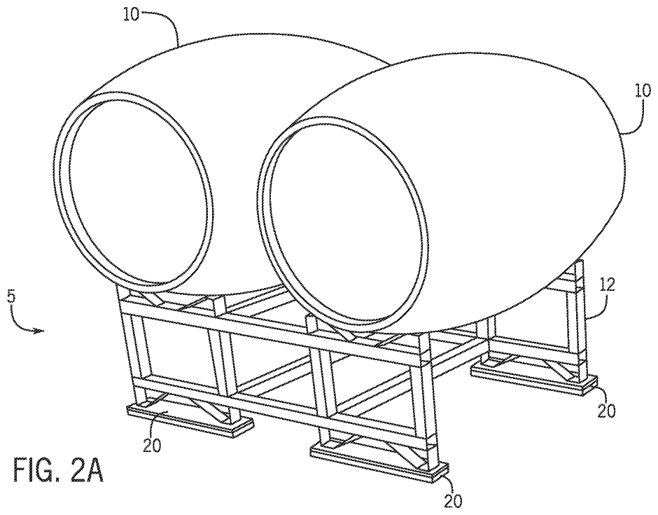

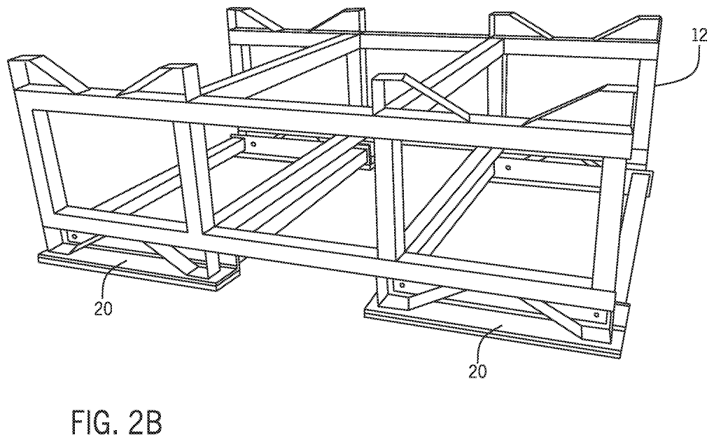

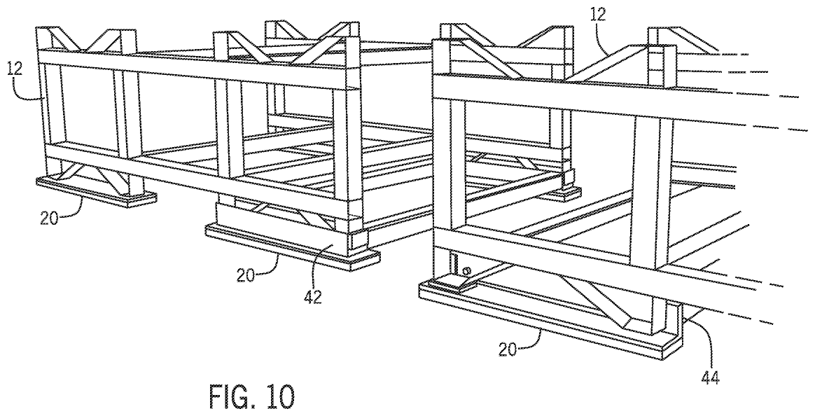

FIG. 2A shows an example isolation system 5 installed, including two containers 10, a container supporting structure 12, and several isolation pads 20. In the shown example, the isolation pads 20 are welded to the container supporting structure 12. Other means of attaching isolation pads 20 and the container supporting structure 12 are shown and discussed below with respect to FIG. 10. FIG. 2B shows another example of the container supporting structure 12 and isolation pads 20 without containers 10 loaded onto it.

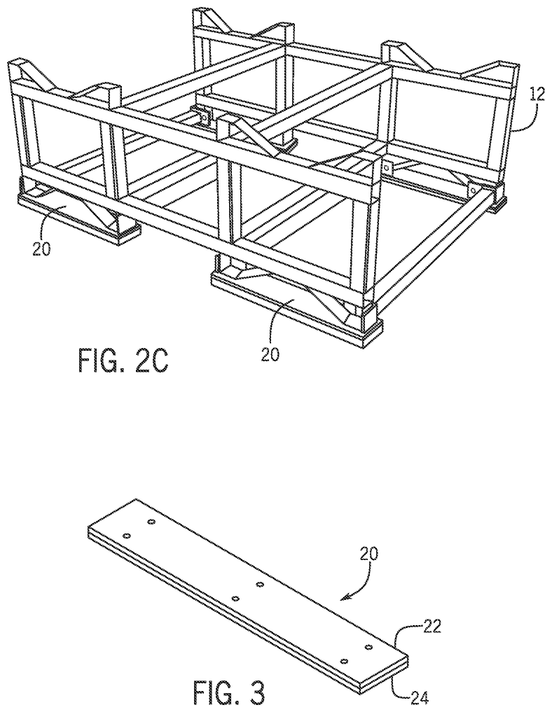

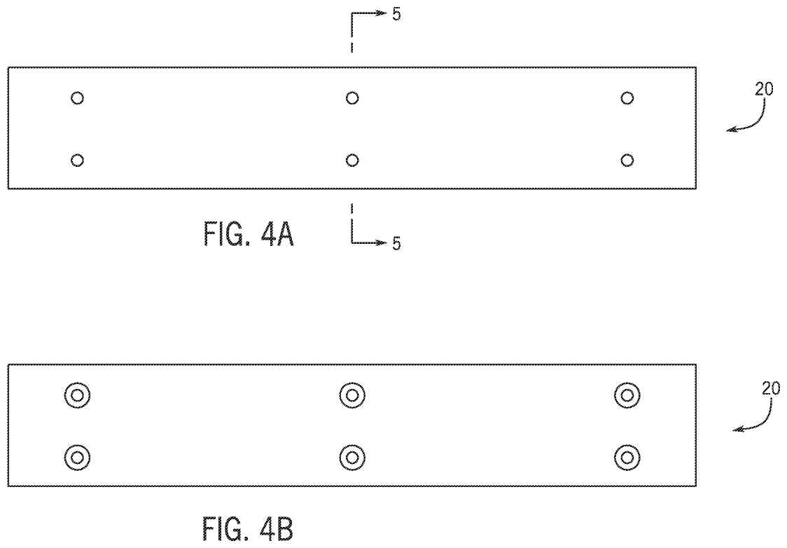

In FIG. 3, an example isolation pad 20 is shown alone. In this example, isolation pad 20 comprises a plate 22 and an underlayer 24. In this view, the plate 22 and the underlayer 24 are visible. In the example shown, the plate 22 is made of 0.25″ corrosion resistant steel and the underlayer 24 is high-density polyethylene. In the example shown, these pieces are held together with mechanical fasteners (discussed below) inserted into threaded holes 26. FIG. 4A shows the isolation pad 20 from a top view and 4B shows this from a bottom.

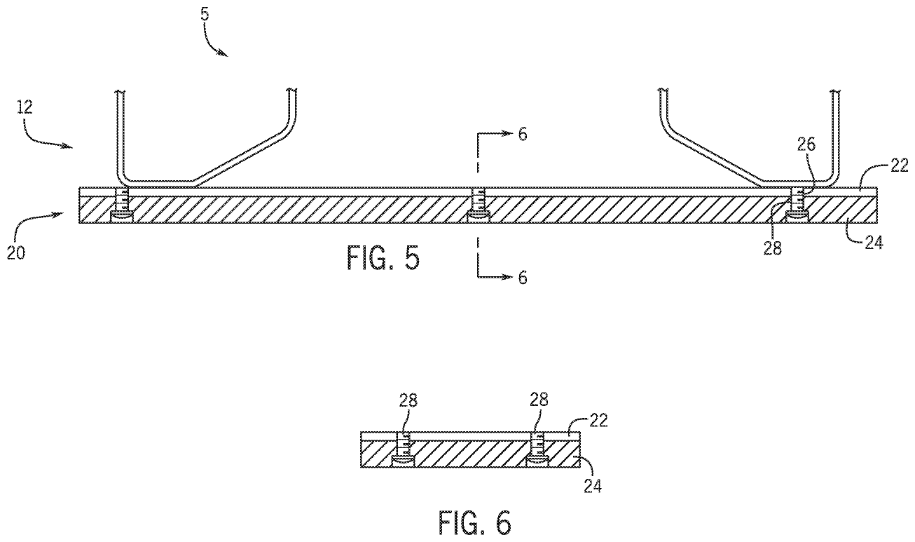

FIG. 5 is a cross-sectional view of the isolation system 5 taken through section 5-5 in FIG. 3, a front elevated view internal to the system, showing both the isolation pad 20 and the container holding structure 12. In the example shown, the attachment mechanism between the plate 22 and underlayer 24 is visible. A screw 28 fits into a threaded hole 26 which runs through both the plate 22 and the underlayer 24. One of ordinary skill will appreciate that this is just one method of joining the plate 22 and the underlayer 24, which could also include adhesives, interlocking parts, or other suitable means.

FIG. 6 is a cross-sectional view of the isolation pad 20 taken through section 6-6 in FIG. 5. This shows the internal isolation pad 20 from a side elevated view. In this view, a second row of screws 28 can be seen piercing through the plate 22 and the underlayer 24.

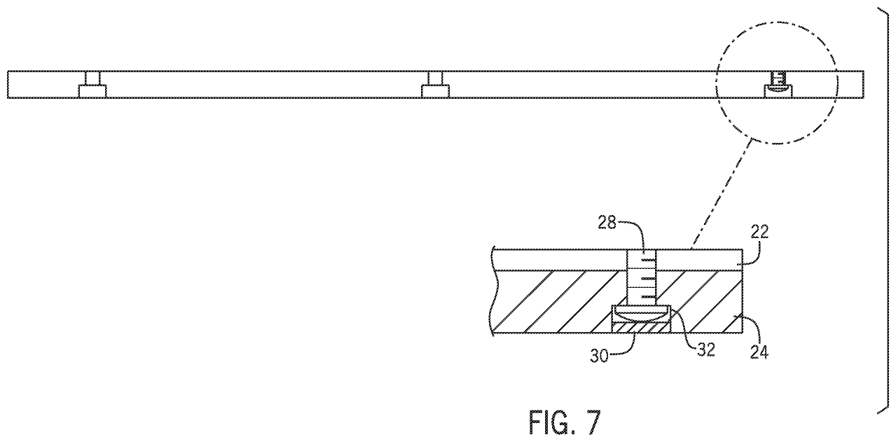

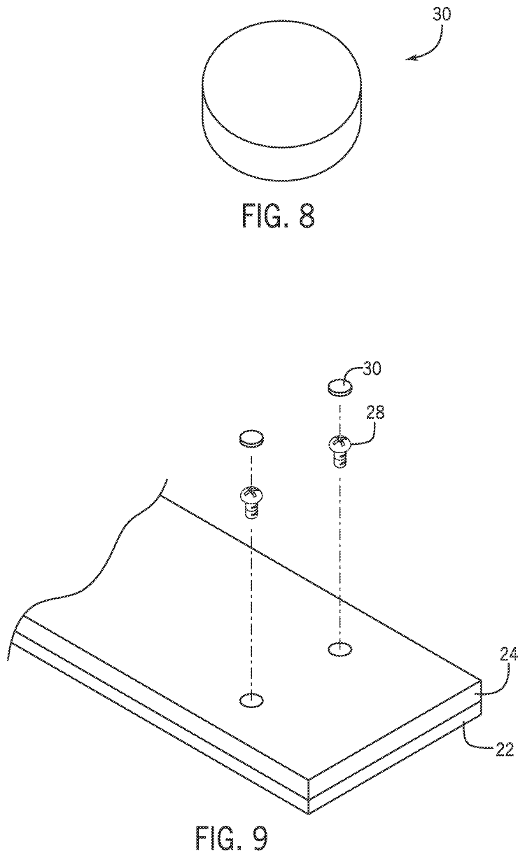

FIG. 7 is a detailed view of attachment discussed above and first shown in FIG. 5. In this instance, in order to maintain a low coefficient of friction with the foundation, the screws 28 cannot directly contact the foundation even if the underlayer 24 deforms under loading conditions such several full barrels of wine atop the assembly. To do so, screw 28 is covered with a cap 30 and inset into to a counterbored hole 32 to create a flush surface. The cap 30, shown alone in FIG. 8, is made of the same material as the underlayer 24 and is press fit into a counterbored hole 32. FIG. 9 is an exploded view of the parts shown in FIG. 6.

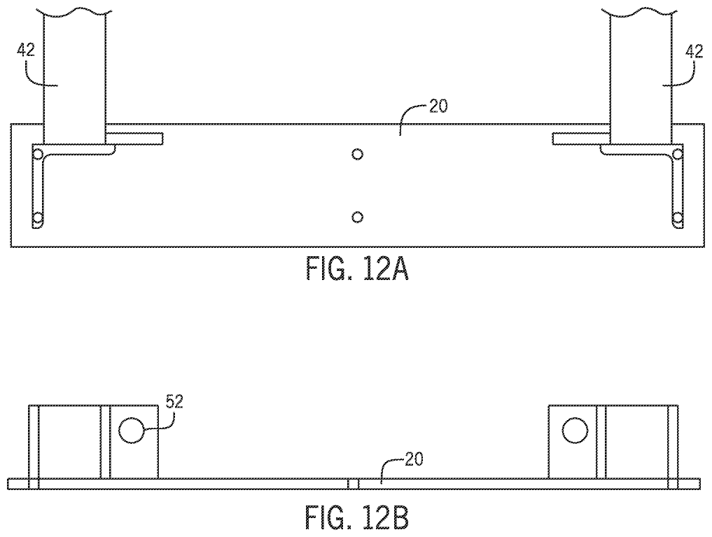

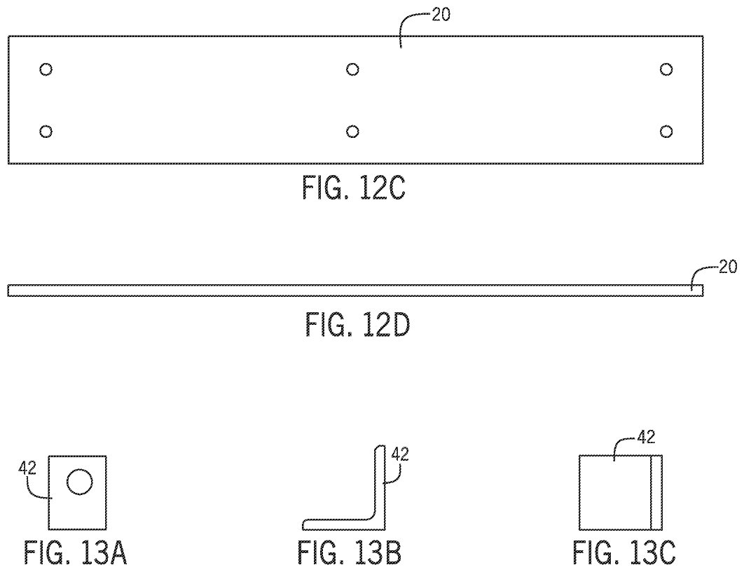

FIG. 10 shows a variety of methods of attaching the parts of the isolation system 5. A variety of means can be used to hold the container holding structure 12 and isolation pad 20 including welding as was mentioned above. In the figure, three attachment structures are shown. The leftmost isolation pad 20 shows the welded example previously shown in FIG. 12. The middle isolation pad 20 has a multi-sided receiving structure 42 that made is made to fit a part of the container holding structure 12. In this example shown, the receiving structure is shaped to hold the lateral sides of the feet of the container receiving structure 12. Another example shown on the rightmost isolation pad 20 is the single sided receiving structure 44, which is fitted against the feet of the container receiving structure 12. This method allows more flexibility than multi-sided receiving structure 42.

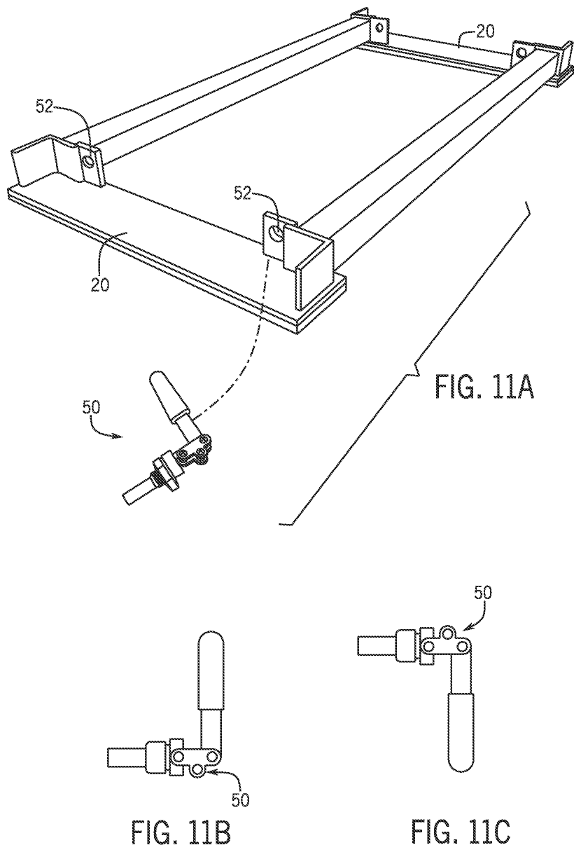

FIG. 11A shows yet another example of the isolation system 5. This version uses a releasable connector, such as toggle bolts 50, to secure the container holding structure 12 to the isolation pad 20. The toggle bolts are shown in FIGS. 11B and 11C in their closed and open positions respectively. The toggle bolts 50 are inserted through apertures 52 in the receiving structure 42 as shown in FIG. 11A. FIG. 12A shows this example isolation system 5 from a top view, while FIG. 12B shows a bottom view. FIG. 12C shows the example isolation pad 20 of the system 5 shown in FIG. 11 and FIG. 12D shows the pad 20 from a side view. The receiving structure 42 is shown in FIG. 13A-C with aperture 52.

Although certain example methods and apparatus have been described herein, the scope of coverage of this patent is not limited hereto. On the contrary, this patent covers all methods, apparatus, and articles of manufacture fairly falling within the scope of the appended claims either literally or under the doctrine of equivalent.

We claim:

1. An base isolation system for a container comprising:
a plate positioned between the container and a foundation;
an underlayer affixed to a surface of the plate facing the foundation; and
a releasable connector for securing the container to the plate
wherein the underlayer is selected to provide a coefficient of static and kinetic friction between the underlayer and the foundation that prevents relative movement of the isolation pad and foundation in normal operation and yet allows the isolation pad to move relative to the foundation during a seismic event.

2. The base isolation system of claim 1, wherein the foundation is altered to achieve the coefficient of static and kinetic friction between the underlayer and the foundation that prevents relative movement of the isolation pad and foundation in normal operation and yet allows the isolation pad to move relative to the foundation during a seismic event.

3. The base isolation system of claim 2, wherein the foundation is a concrete floor.

4. The base isolation system of claim 2, wherein the alteration to the foundation is polishing.

5. The base isolation system of claim 1, further comprising a container holding structure between the container and the plate.

6. The base isolation system of claim 1, further comprising a damper connected to the foundation and the plate.

7. The base isolation system of claim 1, further comprising a lubricant disposed between the underlayer and the foundation to reduce the coefficient of static and kinetic friction.

8. The base isolation system of claim 1, wherein the releasable connector is a toggle bolt.

9. The base isolation system of claim 5, wherein the releasable connector is operably located between the container holding structure and the plate.

10. The base isolation system of claim 5, further including a receiving structure for inserting a part of the container holding structure.

11. A method of isolating the base of a container comprising:
positioning a plate between the container and a foundation;
adding an underlayer to a plate to create an isolation pad wherein the underlayer is selected to provide a coefficient of static and kinetic friction between the underlayer and the foundation that prevents relative movement of the isolation pad and foundation in normal operation and yet allows the isolation pad to move relative to the foundation during a seismic event;
securing the container to the plate with a releasable connector; and
optionally polishing or otherwise altering the foundation (e.g., floor or ground) to refine the coefficient of friction.
